(19) United States
(12) Patent Application Publication
(10) Pub. No.: US 2018/0312260 A1
(43) Pub. Date: Nov. 1, 2018

(54) CONFIGURABLE HIGH RATE CLOSED LOOP SMART VALVE CONTROL

(71) Applicant: Hamilton Sundstrand Corporation, Charlotte, NC (US)

(72) Inventors: Christopher Grant, Chicopee, MA (US); John M. Maljanian, JR., Farmington, CT (US)

(21) Appl. No.: 15/660,531

(22) Filed: Jul. 26, 2017

Related U.S. Application Data
(60) Provisional application No. 62/490,782, filed on Apr. 27, 2017.

(51) Int. Cl. B64D 13/06; F02C 6/08

(52) U.S. Cl. CPC B64D 13/06; B64D 2013/0618; F02C 6/08

(57) ABSTRACT

A distributed control system includes a local feedback controller, a sensor, and a controller. The local feedback controller is in communication with an actuator arranged to control a position of a valve associated with a conduit. The sensor is arranged to provide a signal indicative of at least one of a pressure, flow rate, and a temperature of a fluid within the conduit to the local feedback controller. The controller is programmed to provide a target control reference to the local feedback controller.

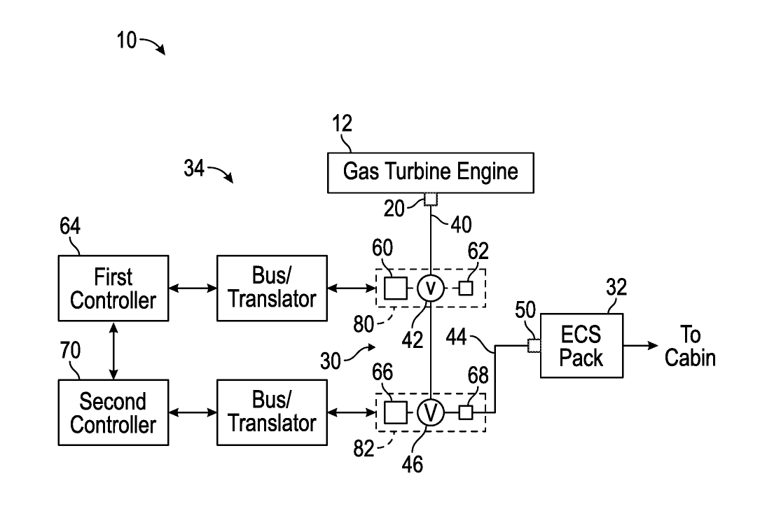

### CROSS-REFERENCE TO RELATED APPLICATIONS

This application claims the benefit of U.S. Provisional Application Ser. No. 62/490,782 filed Apr. 27, 2017, which is incorporated herein by reference in its entirety.

### BACKGROUND

Aircraft are commonly provided with an environmental control system that provides conditioned air to a cabin of the aircraft. The environmental control system may condition air drawn from a gas turbine engine and provide the air to the cabin. A pneumatic control system may regulate the delivery of the air drawn from the gas turbine engine and provided to the environmental control system. However, the control of valves of the pneumatic control system may be unstable due to pressure fluctuations and other dynamic effects. Accordingly it is desirable to provide a more stable and robust pneumatic control system.

### BRIEF DESCRIPTION

Disclosed is an environmental control system for an aircraft. The environmental control system that includes a first valve and a first controller. The first valve is positioned to selectively facilitate bleed air to flow from a first bleed air port of a gas turbine engine to an environmental control system pack. The first valve is in communication with a first local feedback controller that is programmed to control a position of the first valve based on a first target control reference. The first controller being programmed to provide the first target control reference to the first local feedback controller.

Also disclosed is an environmental control system for an aircraft. The environmental control system includes a valve assembly, a first controller, and a second controller. The valve assembly has a first valve and a second valve. The first valve is positioned to selectively facilitate bleed air to flow from a first bleed air port of a gas turbine engine to the second valve. The first valve is in communication with a first local feedback controller. The second valve is positioned to selectively facilitate bleed air to flow from the first valve to an environmental control system pack. The second valve is in communication with a second local feedback controller. The first controller is programmed to provide a first target control reference to the first local feedback controller. The second controller is programmed to provide a second target control reference to the second local feedback controller.

Further disclosed is a distributed control system for an environmental control system. The distributed control system includes a local feedback controller, a sensor, and a controller. The local feedback controller is in communication with an actuator arranged to control a position of a valve associated with a conduit. The sensor is arranged to provide a signal indicative of at least one of a pressure, flow rate, and a temperature of a fluid within the conduit to the local feedback controller. The controller is spaced apart from the local feedback controller. The controller is programmed to provide a target control reference to the local feedback controller.

### BRIEF DESCRIPTION OF THE DRAWINGS

The following descriptions should not be considered limiting in any way. With reference to the accompanying drawings, like elements are numbered alike:

The FIGURE is a schematic diagram of an environmental control system of an aircraft.

### DETAILED DESCRIPTION

A detailed description of one or more embodiments of the disclosed apparatus and method are presented herein by way of exemplification and not limitation with reference to the FIGURES.

Referring to the FIGURE, a schematic diagram of an environmental control system 10 of an aircraft is illustrated. The environmental control system 10 is configured to receive bleed air from an engine such as a gas turbine engine 12.

The gas turbine engine 12 includes a fan section, a compressor section, a combustor section, and a turbine section all arranged sequentially and form a core flow path through the gas turbine engine 12. The compressor defines or is provided with a first bleed air port 20 that enables the environmental control system 10 to receive air bled from a low pressure compressor and/or a high pressure compressor of the compressor.

The environmental control system 10 includes a valve assembly 30, an environmental control system pack (ECS pack) 32, and a control system 34.

The valve assembly 30 selectively facilitates air to be bled and flow from the gas turbine engine 12 and be provided to the ECS pack 32. The valve assembly 30 includes a first conduit 40, a first valve 42, a second conduit 44, and a second valve 46.

The first conduit 40 extends from the gas turbine engine 12 to the first valve 42 and the second valve 46. The first conduit 40 is fluidly connected to the first bleed air port 20, the first valve 42, and the second valve 46.

The first valve 42 is operatively connected to the first conduit 40 and selectively inhibits or permits bleed air to flow from the first bleed air port 20 to the second valve 46. The first valve 42 includes an actuator that is arranged to change a position of the first valve 42 between a plurality of positions including an open position and a closed position. The actuator may be a power operated actuator such as a pneumatic regulating torque motor, an AC motor, a DC motor, or the like. In at least one embodiment, the actuator may be provided with a switch or position feedback mechanism that provides a first valve position signal indicative of the position of the first valve 42 to the control system 34.

The second conduit 44 extends from the second valve 46 to the ECS pack 32. The second conduit 44 is fluidly connected to the second valve 46 and a port 50 of the ECS pack 32.

The second valve 46 is fluidly connected in series with the first valve 42 by the first conduit 40. The second valve 46 is operatively connected to the second conduit 44 and selectively inhibits or permits bleed air to flow from the first valve 42 to the port 50 of the ECS pack 32. The second valve 46 includes an actuator that is arranged to change a position of the second valve 46 between a plurality of positions including an open position and a closed position. The actuator may be a power operated actuator such as a pneumatic regulating torque motor, an AC motor, a DC motor, or the like. In at least one embodiment, the actuator may be provided with a switch or position feedback mechanism that provides a second valve position signal indicative of the position of the second valve 46 to the control system 34.

The ECS pack 32 is selectively enabled to receive bleed air from the gas turbine engine 12. The ECS pack 32 may include a turbine driven fan or compressor, heat exchangers, and an outlet to the cabin of the aircraft. The bleed air may be conditioned by the ECS pack 32 (heated, cooled, dried, etc.) and provided to the cabin of the aircraft via the outlet.

The control system 34 may be a distributed control system that controls a position of the first valve 42 and the second valve 46. The control system 34 includes a first local feedback controller 60, a first sensor 62, a first controller 64, a second local feedback controller 66, a second sensor 68, and a second controller 70.

The first local feedback controller 60 is in communication with the actuator of the first valve 42, the first sensor 62, and the first controller 64. The first local feedback control 60 is programmed to control a position of the first valve 42 that is associated with the first conduit 40. The first local feedback controller 60 is at least one of a field programmable gate array, a microcontroller, or a microprocessor installed locally with respect to the first valve 42. The first local feedback control 60 may be integrated with the first valve 42, may be disposed proximate the first valve 42, may be integrated with the first sensor 62, and is completely spaced apart from the first controller 64.

The first local feedback controller 60 is programmed to control a position of the first valve 42 based on a first signal provided by the first sensor 62 and a first target control reference provided by the first controller 64. The first signal provided by the first sensor 62 is a signal indicative of at least one of a pressure, flow rate, and a temperature of bleed air within the first conduit 40. As such, the first sensor 62 may be a pressure sensor, a flowmeter, a temperature sensor, or the like that is positioned to monitor a characteristic of the bleed air within the first conduit 40. The first sensor 62 may be integrated with or provided as part of the first local feedback controller 60. The first local feedback controller 60, the first sensor 62, and the first valve 42 may be integrated together or provided together to define a first local control unit 80.

The first controller 64 is completely spaced apart from the first local feedback controller 60. The first controller 64 is programmed to provide the first target control reference to the first local feedback controller 60. The first target control reference may be a first target position of the first valve 42, a target voltage output of the actuator of the first valve 42, a target current output of the actuator of the first valve 42, a target pressure of the bleed air within the first conduit 40, a target temperature of the bleed air within the first conduit 40, or a target flow rate of the bleed air within the first conduit 40.

The first controller 64 provides the first target control reference to the first local feedback controller 60 through a remote data concentrator, translator, or digital communications bus. The first local feedback control 60 receives the first target control reference and controls or drives the actuator such that the first target control reference is achieved and bleed air from the gas turbine engine 12 is received by the ECS pack 32. The first local feedback controller 60 runs a closed loop control between 250 Hz and 10 kHz to provide localized real-time control of the first valve via the actuator, based on the first signal provided by the first sensor 62 and the first target control reference provided by the first controller 64 via the remote data concentrator or digital communications bus.

The second local feedback controller 66 is in communication with the actuator of the second valve 46, the second sensor 68, and the second controller 70. The second local feedback control 66 is programmed to control a position of the second valve 46 that is associated with the second conduit 44. The second local feedback controller 66 is at least one of a field programmable gate array, a microcontroller, or a microprocessor installed locally with respect to the second valve 46. The second local feedback control 66 may be integrated with the second valve 46, may be disposed proximate the second valve 46, may be integrated with the second sensor 68, and is completely spaced apart from the second controller 70.

The second local feedback controller 66 is programmed to control a position of the second valve 46 based on a second signal provided by the second sensor 68 and a second target control reference provided by the second controller 70. The second signal provided by the second sensor 68 is a signal indicative of at least one of a pressure, flow rate, and a temperature of bleed air within the second conduit 44. As such, the second sensor 68 may be a pressure sensor, a flowmeter, a temperature sensor, or the like that is positioned to monitor a characteristic of the bleed air within the second conduit 44. The second sensor 68 may be integrated with or provided as part of the second local feedback controller 66. The second local feedback controller 66, the second sensor 68, and the second valve 46 may be integrated together or provided together to define a second local control unit 82.

The second controller 70 is completely spaced apart from the second local feedback controller 66. The second controller 70 is programmed to provide the second target control reference to the second local feedback controller 66. The second target control reference may be a second target position of the second valve 46, a target voltage output of the actuator of the second valve 46, a target current output of the actuator of the second valve 46, a target pressure of the bleed air within the second conduit 44, a target temperature of the bleed air within the second conduit 44, or a target flow rate of the bleed air within the second conduit 44.

The second controller 70 provides the second target control reference to the second local feedback controller 66 through a remote data concentrator, translator, or digital communications bus. The second local feedback control 66 receives the second target control reference and controls or drives the actuator such that the second target control reference is achieved and bleed air from the gas turbine engine 12 is received by the ECS pack 32. The second local feedback controller 66 runs a closed loop control between 250 Hz and 10 kHz to provide localized real-time control of the first valve via the actuator, based on the second signal provided by the second sensor 68 and the second target control reference provided by the second controller 70 via the remote data concentrator or digital communications bus.

The local feedback controllers being located locally with their respective valves improves the performance of the bleed air system and the environmental control system 10 and provides distributed control system architecture. The distributed control system architecture using the local feedback controllers in conjunction with the controllers enables a more stable controlling of the position of the valves. Furthermore, the externally provided target control reference improves the response time of the valves.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system for an aircraft, comprising:
a first valve positioned to selectively facilitate bleed air to flow from a first bleed air port of a gas turbine engine to an environmental control system pack, the first valve being in communication with a first local feedback controller programmed to control a position of the first valve based on a first target control reference; and
a first controller being programmed to provide the first target control reference to the first local feedback controller.

2. The environmental control system of claim 1, wherein the first target control reference is at least one of a target position of the first valve and a voltage and/or current output of an actuator associated with the first valve.

3. The environmental control system of claim 1, wherein the first local feedback controller is integrated with the first valve.

4. The environmental control system of claim 1, wherein the first local feedback controller is in communication with a first sensor positioned to provide a first signal indicative of at least one of a pressure, flow rate, and a temperature of bleed air within a conduit associated with the first bleed air port.

5. The environmental control system of claim 4, wherein the first local feedback controller is further programmed to control the position of the first valve based on the first signal.

6. The environmental control system of claim 4, wherein the first sensor is integrated with at least one of the first valve and the first sensor.

7. An environmental control system for an aircraft, comprising:
a valve assembly having:
a first valve that is positioned to selectively facilitate bleed air to flow from a first bleed air port of a gas turbine engine to a second valve that is positioned to selectively facilitate bleed air to flow from the first valve to an environmental control system pack, the first valve being in communication with a first local feedback controller and the second valve being in communication with a second local feedback controller;
a first controller being programmed to provide a first target control reference to the first local feedback controller; and
a second controller being programmed to provide a second target control reference to the second local feedback controller.

8. The environmental control system of claim 7 further comprising: a first sensor positioned to provide a first signal indicative of at least one of a pressure, flow rate, and a temperature of bleed air within a first conduit associated with the first bleed air port to the first local feedback controller.

9. The environmental control system of claim 8 further comprising: a second sensor positioned to provide a second signal indicative of at least one of a pressure, flow rate, and a temperature of bleed air within a second conduit associated with the port to the second local feedback controller.

10. The environmental control system of claim 9, wherein the first local feedback controller is programmed to control a position of the first valve based on the first target control reference and the first signal.

11. The environmental control system of claim 10, wherein the first target control reference is a first target position of the first valve.

12. The environmental control system of claim 9, wherein the second local feedback controller is programmed to control a position of the second valve based on the second target control reference and the second signal.

13. The environmental control system of claim 12, wherein the second target control reference is at least one of a second target position of the second valve, a target pressure, a target flow rate, and a target temperature.

14. A distributed control system for and environmental control system, comprising:
a local feedback controller in communication with an actuator arranged to control a position of a valve associated with a conduit;
a sensor being arranged to provide a signal indicative of at least one of a pressure, flow rate, and a temperature of a fluid within the conduit to the local feedback controller; and
a controller spaced apart from the local feedback controller, the controller being programmed to provide a target control reference to the local feedback controller.

15. The distributed control system of claim 14, wherein the sensor is integrated with the local feedback controller.

16. The distributed control system of claim 14, wherein the local feedback controller is integrated with the valve.

17. The distributed control system of claim 14, wherein the local feedback controller is programmed to operate the actuator to control the position of the valve based on the signal and the target control reference.

18. The distributed control system of claim 14, wherein the target control reference is a target position of the valve.

19. The distributed control system of claim 14, wherein the target control reference is at least one of a target voltage output and a target current output of the actuator.

20. The distributed control system of claim 14, wherein the target control reference is at least one of a target pressure and a target flow rate of the fluid within the conduit.
